(19) United States
(12) Patent Application Publication
(10) Pub. No.: US 2014/0203207 A1
(43) Pub. Date: Jul. 24, 2014

(54) ANODE ACTIVE MATERIAL FOR SECONDARY BATTERY AND METHOD OF MANUFACTURING THE SAME

(71) Applicant: MK ELECTRON CO., LTD., Yongin-si (KR)

(72) Inventors: Hee Sang Jeon, Seongnam-si (KR); Jong Soo CHO, Seoul (KR); Jeong Tak MOON, Suwon-si (KR)

(73) Assignee: MK ELECTRON CO., LTD., Yongin-si (KR)

(21) Appl. No.: 13/746,806

(22) Filed: Jan. 22, 2013

(51) Int. Cl. H01M 4/38; C01B 33/00

(52) U.S. Cl. CPC H01M 4/386; C01B 33/00
USPC 252/182.1

(57) ABSTRACT

An anode active material for a lithium secondary battery having high-capacity and high-efficient charging/discharging characteristics. The anode active material includes silicon single phases, and silicon-metal alloy phases distributed around the silicon single phases. The silicon single phases have a fine structure in which crystalline particles obtained through rapid-cooling solidification are thermally treated to be grown to crystal grains.

### BACKGROUND OF THE INVENTION

1. Field of the Invention

One or more aspects of the present invention relate to a secondary battery, and more particularly, to an anode active material for a secondary battery having a high capacity and high-efficient charging/discharging characteristics and a method of manufacturing the same.

2. Description of the Related Art

Recently, use of lithium secondary batteries has been rapidly expanded to various application fields. For example, lithium secondary batteries have been used as not only power sources for portable electronic products, e.g., mobile phones and notebook computers, but also medium/large-scale power sources for hybrid electric vehicles (HEV), plug-in HEVs, and so on. As application fields have expanded and demands therefor have increased, external shapes and sizes of batteries have diversified and there is a growing need for batteries having higher capacity, extended cycle-life, and better safety than those of conventional small-sized batteries.

In general, a lithium secondary battery is manufactured by using materials which lithium ions can be intercalated into and deintercalated from, as an anode and a cathode, forming a porous separator between the anode and the cathode, and injecting an electrolyte solution into the anode, the cathode, and the porous separator. Electric current is produced or consumed due to a redox reaction caused by intercalation/deintercalation of lithium ions in the anode and the cathode.

Graphite is an anode active material that has been widely used in the field of conventional lithium secondary batteries, and has a layered structure which lithium ions can be easily intercalated into and deintercalated from. Although graphite has a theoretical capacity of 372 mAh/g, a new electrode material that can replace graphite is required as demands for high-capacity lithium batteries have increased. Thus, research has been actively conducted on commercialization of an electrode active material that can form electrochemical alloy with lithium ions, such as silicon (Si), tin (Sn), antimony (Sb), and aluminum (Al), as a high-capacity anode active material. However, when silicon (Si), tin (Sn), antimony (Sb), aluminum (Al), or the like are electrochemically plated with lithium, the volume of the resultant structure increases or decreases during a charge/discharge process. Such a volume change deteriorates cycle characteristics of an electrode employing silicon (Si), tin (Sn), antimony (Sb), aluminum (Al), or the like as an anode active material. Furthermore, such a volume change causes cracks in a surface of the anode active material. When cracks occur repeatedly in the surface of the electrode active material, fine particles may be formed in the surface of the electrode, thereby deteriorating cycle characteristics.

### SUMMARY OF THE INVENTION

The present invention provides an anode active material for a secondary battery having a high capacity and high-efficient charge/discharge characteristics.

The present invention also provides a method of manufacturing the anode active material for a secondary battery.

The present invention provides a secondary battery including the anode active material.

According to an aspect of the present invention, there is provided an anode active material for a secondary battery, including silicon single phases; and silicon-metal alloy phases distributed around the silicon single phases. The silicon single phases have a fine structure in which crystalline particles obtained through rapid-cooling solidification are thermally treated to be grown to crystal grains.

The silicon single phases may include a fine structure obtained when a dendrite structure formed through the rapid-cooling solidification is decomposed.

The silicon single phases may include a fine structure, the directionality of growth of which is canceled through the thermal treatment.

The silicon single phases and the silicon-metal alloy phases may form a spongiform fine structure.

The silicon single phases may include crystal grains, each of which has a diameter of 100 nm to 300 nm.

A degree of crystallization of the silicon-metal alloy phases may be higher than that of initial phases obtained through the rapid-cooling solidification.

The silicon-metal alloy phases may include at least one metal selected from the group consisting of Ti, Ni, Fe, Mn, Al, Fe, Cr, and Co.

The silicon-metal alloy phases may include silicon, nickel, and titanium.

The thermal treatment may be performed at 700° C. to 750° C.

According to another aspect of the present invention, there is provided a method of manufacturing an anode active material for a secondary battery, the method including melting silicon and a metal material together to form a molten mixture; rapid cooling the molten mixture to be solidified to form a rapidly solidified structure including silicon single phases and silicon-metal alloy phases; thermally treating the rapidly solidified structure to grow the silicon single phases, the silicon-metal alloy phases, or both the silicon single phases and the silicon-metal alloy phases to obtain crystal grains; and forming an anode active material by grinding the thermally treated rapidly solidified structure.

According to another aspect of the present invention, there is provided a method of manufacturing an anode active material for a secondary battery, the method including melting silicon and a metal material together to form a molten mixture; rapid cooling the molten mixture to be solidified to form a rapidly solidified structure including silicon single phases and silicon-metal alloy phases; grinding the thermally treated rapidly solidified structure; and forming an anode active material by thermally treating the grinded rapidly solidified structure such that the silicon single phases, the silicon-metal alloy phases, or both the silicon single phases and the silicon-metal alloy phases are grown to crystal grains.

According to another aspect of the present invention, there is provided a secondary battery including an anode active material including: silicon single phases; and silicon-metal alloy phases distributed around the silicon single phases. The silicon single phases have a fine structure in which crystalline particles obtained through rapid-cooling solidification are thermally treated to be grown to crystal grains.

An anode active material for a secondary battery according to an embodiment of the present invention is formed by performing rapid-cooling solidification and then performing thermal treatment. The anode active material includes silicon single phases and silicon-metal alloy phases. In general, the volume of silicon single phases increases since lithium ions are intercalated thereinto/deintercalated therefrom during charging/discharging of a lithium secondary battery. In contrast, silicon single phases according to the present invention have an evenly distributed fine structure in which no dendrite structure is found. Thus, the silicon single phases are highly resistant to stress caused by such a volume change and may prevent crack from occurring. Also, since the anode active material has a spongiform structure in which silicon-metal alloy phases are distributed around the silicon single phases, the spongiform structure may buffer such a volume change, thereby greatly increasing the resistance to the stress caused by the volume change. Accordingly, the secondary battery may have a high initial charge capacity and good cycle-life characteristics.

### BRIEF DESCRIPTION OF THE DRAWINGS

The above and other features and advantages of the present invention will become more apparent by describing in detail exemplary embodiments thereof with reference to the attached drawings in which:

FIG. 1 schematically illustrates a secondary battery according to an embodiment of the present invention;

FIGS. 2 and 3 schematically illustrate an anode and a cathode included in the secondary battery of FIG. 1, respectively;

FIG. 4 is a flowchart illustrating a method of manufacturing an anode active material included in an anode of a secondary battery according to an embodiment of the present invention;

FIG. 5 is a flowchart schematically illustrating a method of manufacturing an anode active material according to another embodiment of the present invention;

FIG. 6 is a diagram schematically illustrating a method of forming an anode active material according to an embodiment of the present invention;

FIG. 7 illustrates scanning electronic microscopic (SEM) image illustrating microstructures of rapidly solidified structures including silicon, nickel, and titanium, according to an embodiment of the present invention;

FIG. 8 illustrates SEM image illustrating microstructures of rapidly solidified structures including silicon, nickel, and titanium, according to another embodiment of the present invention;

FIG. 9 illustrates graphs showing X-ray diffraction patterns of solidified bodies including silicon, nickel, and titanium, according to an embodiment of the present invention; and

FIGS. 10 and 11 are graphs showing a relationship between a capacity change and number of cycles of a secondary battery having an anode formed using a rapidly solidified structure including silicon, nickel, and titanium, according to an embodiment of the present invention.

### DETAILED DESCRIPTION OF THE INVENTION

Hereinafter, exemplary embodiments of the present invention will be described in greater detail with reference to the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those of ordinary skill in the art. As used herein, the term ‘and/or’ includes any and all combinations of one or more of the associated listed items. In the drawings, the same reference numerals denote the same elements, and the thickness of layers and regions may be exaggerated for clarity. Thus, the technical idea of the present invention is not limited by the relative sizes or intervals illustrated in the accompanying drawings. In the embodiments, the term ‘wt % (weight %)’ denotes a percentage into which the weight of a substance of the total weight of an alloy is converted. Expressions such as “at least one of,” when preceding a list of elements, modify the entire list of elements and do not modify the individual elements of the list.

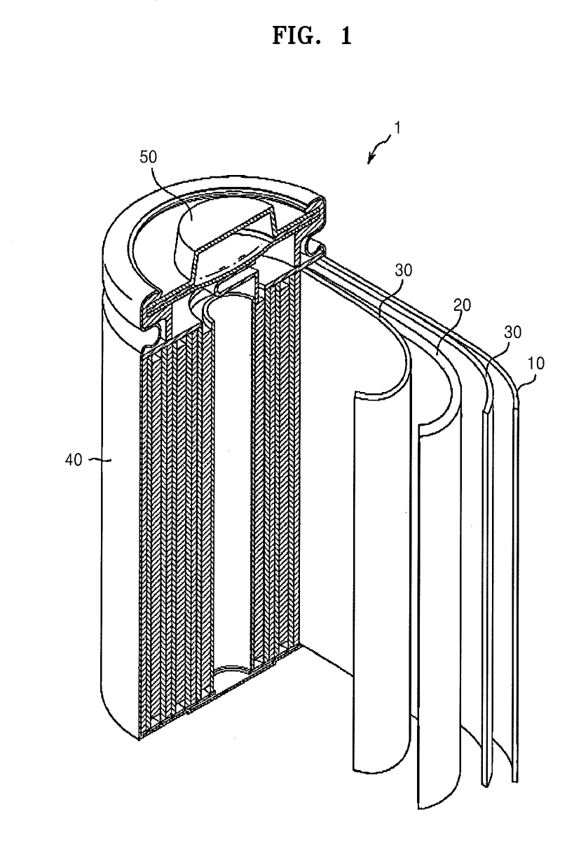

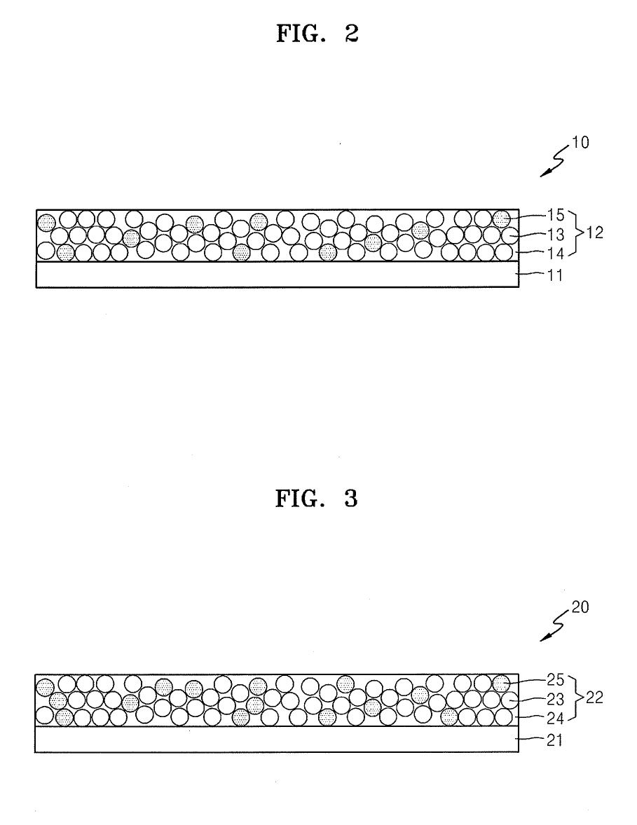

FIG. 1 schematically illustrates a secondary battery 1 according to an embodiment of the present invention. FIGS. 2 and 3 schematically illustrate an anode 10 and a cathode 20 included in the secondary battery 1 of FIG. 1, respectively.

Referring to FIG. 1, the secondary battery 1 may include the anode 10, the cathode 20, a separator 30 between the anode 10 and the cathode 20, a battery case 40, and a sealing member 50. The secondary battery 1 may further include an electrolyte (not shown) with which the anode 10, the cathode 20, and the separator 30 are impregnated. The anode 10, the cathode 20, and the separator 30 may be sequentially stacked and then be accommodated in the battery case 40 in a spirally wound state. The battery case 40 may be sealed with the sealing member 50.

The secondary battery 1 may be a lithium secondary battery using lithium as a medium, and may be classified as a lithium ion battery, a lithium ion polymer battery, or a lithium polymer battery according to the types of the separator 30 and an electrolyte. Otherwise, the secondary battery 1 may be classified as a coin type, a button type, a sheet type, a cylindrical type, a flat type, or a pouch type according to a shape, or may be classified as a bulk type or a thin film type according to a size. FIG. 1 illustrates the secondary battery 1 as a cylindrical type secondary battery but the present invention is not limited thereto.

Referring to FIG. 2, the anode 10 includes an anode current collector 11 and an anode active material layer 12 on the anode current collector 11. The anode active material layer 12 includes an anode active material 13, and an anode binder 14 that binds particles of the anode active material 13 together. Alternatively, the anode active material layer 12 may further include an anode conductive material 15. Although not shown, the anode active material layer 12 may further include an additive, such as a filler or a dispersing agent. The anode 10 may be formed by mixing the anode active material 13, the anode binder 14, and/or the anode conductive material 15 in a solvent to obtain a mixture including an anode active material, and applying the mixture on the anode current collector 11.

The anode current collector 11 may include a conductive material, e.g., a thin conductive foil. The anode current collector 11 may include, for example, copper, gold, nickel, stainless steel, titanium, or an alloy thereof. Otherwise, the anode current collector 11 may be a polymer including conductive metal. Otherwise, the anode current collector 11 may be formed by compressing an anode active material.

The anode active material 13 may be, for example, an anode active material for a lithium secondary battery, and may include a material which lithium ions may be reversibly intercalated into/deintercalated from. The anode active material 13 may include, for example, silicon and metal, and may consist of, for example, silicon particles dispersed in a silicon-metal matrix. The metal may be a transition metal, e.g., at least one species selected from the group consisting of Al, Cu, Zr, Ni, Ti, Co, Cr, V, Mn, and Fe. Each of the silicon particles may be nano-sized particles. Tin, aluminum, antimony, or the like may be used instead of silicon. The anode active material 13 may include silicon of 40 wt % to 80 wt % of the total weight of the anode active material 13, and particularly, silicon of 60 wt % to 70 wt % of the total weight of the anode active material 13. The anode active material 13 will be described in detail with reference to a preparation example below.

The anode binder 14 may bind the particles of the anode active material 13 together, and binds the anode active material 13 with the anode current collector 11. The anode binder 14 may be, for example, a polymer, such as polyimide, polyamideimide, polybenzimidazole, polyvinyl alcohol, carboxyl methylcellulose, hydroxypropyl cellulose, polyvinyl chloride, carboxylated polyvinyl chloride, polyvinyl fluoride, ethylene oxide, polyvinyl pyrrolidone, polyurethane, polytetrafluoroethylene, polyvinylidene fluoride, polyethylene, polypropylene, styrene-butadiene, acrylated styrene-butadiene, or epoxy resin.

The anode conductive material 15 may increase conductivity of the anode 10, and may be a conductive material that does not cause a chemical change in the secondary battery 1. For example, the anode conductive material 15 may include a carbon-based material, e.g., graphite, carbon black, acetylene black, or carbon fiber; a metal material, e.g., copper, nickel, aluminum, or silver; a conductive polymeric material, e.g., a polyphenylene derivative; or a conductive material including a mixture thereof.

Referring to FIG. 3, the cathode 20 includes a cathode current collector 21 and a cathode active material layer 22 on the cathode current collector 21. The cathode active material layer 22 includes a cathode active material 23 and a cathode binder 24 that binds particles of the cathode active material 23. Alternatively, the cathode active material layer 22 may further include a cathode conductive material 25. Although not shown, the cathode active material layer 22 may include an additive, such as a filler or a dispersing agent. The cathode 20 may be formed by mixing the cathode active material 23, the cathode binder 24, and/or the cathode conductive material 25 in a solvent to obtain a mixture including a cathode active material, and applying the mixture on the cathode current collector 21.

The cathode current collector 21 may be a thin conductive foil, and may include, for example, a conductive material. The cathode current collector 21 may include, for example, aluminum, nickel, or an alloy thereof. Otherwise, the cathode current collector 21 may be a polymer including a conductive metal. Otherwise, the cathode current collector 21 may be formed by compressing an anode active material.

The cathode active material 23 may be, for example, a cathode active material for a lithium secondary battery, and may include a material which lithium ions may be reversibly intercalated into/deintercalated from. The cathode active material 23 may include a lithium-containing transition metal oxide, a lithium-containing transition metal sulfide, or the like. For example, the cathode active material 23 may include at least one selected from the group consisting of LiCoO₂, LiNiO₂, LiMnO₂, LiMn₂O₄, Li(NiₐCo_{b}Mn_{c})O₂ (0<a<1, 0<b<1, 0<c<1, a+b+c=1), LiNi_{1-y}Co_{y}O₂, LiCo_{1-y}Mn_{y}O₂, LiNi_{1-y}Mn_{y}O₂ (0=Y<1), Li(NiₐCo_{b}Mn_{c})O₄ (0<a<2, 0<b<2, 0<c<2, a+b+c=2), LiMn_{2-z}Ni_{z}O₄, and LiMn_{2-z}Co_{z}O₄ (0<Z<2), LiCoPO₄, and LiFePO₄.

The cathode binder 24 may bind particles of the cathode active material 23 and also binds the cathode active material 23 with the cathode current collector 21. The cathode binder 24 may be, for example, a polymer, such as polyimide, polyamideimides, polybenzimidazole, polyvinyl alcohol, carboxylmethyl cellulose, hydroxypropyl cellulose, polyvinyl chloride, carboxylated polyvinyl chloride, polyvinyl fluoride, ethylene oxide, polyvinyl pyrrolidone, polyurethane, polytetrafluoroethylene, polyvinylidene fluoride, polyethylene, polypropylene, styrene-butadiene, acrylated styrene-butadiene, or epoxy resin.

The cathode conductive material 25 may increase conductivity of the cathode 20, and may be a conductive material that does not cause a chemical change in the secondary battery 1. For example, the cathode conductive material 25 may include a carbon-based material, e.g., graphite, carbon black, acetylene black, or carbon fiber; a metal material, e.g., copper, nickel, aluminum, or silver; a conductive polymeric material, e.g., a polyphenylene derivative; or a conductive material including a mixture thereof.

Referring back to FIG. 1, the separator 30 may be a porous material, and may be a single film or a multi-layered film including two or more layers. The separator 30 may include a polymeric material, e.g., at least one selected from the group consisting of a polyethylene-based polymer, a polypropylene-based material, a polyvinylidene fluoride-based polymer, and a polyolefin-based polymer.

The electrolyte with which the anode 10, the cathode 20, and the separator 30 are impregnated may include a non-aqueous solvent and electrolyte salt. The type of the non-aqueous solvent is not limited if it can be used for a general non-aqueous electrolyte solution. Examples of the non-aqueous solvent may include a carbonated solvent, an ester-based solvent, an ether-based solvent, a ketone-based solvent, an alcohol-based solvent, or a nonprontonic solvent. A non-aqueous solvent or a mixture of two or more non-aqueous solvents may be used. When the mixture of two or more non-aqueous solvents is used, a mixing ratio of the two or more non-aqueous solvents may be appropriately adjusted according to a desired performance of a battery.

The type of the electrolyte salt is not limited if it can be used for a general non-aqueous electrolytic solution. For example, the electrolyte salt may be salt having an A⁺B⁻ structure. Here, ‘A³⁰ ’ may denote alkaline metal positive ions, e.g., as Li⁺, Na⁺, or K⁺, or a combination thereof. ‘B⁻’ may denote negative ions, e.g., PF₆⁻, BF₄⁻, Cl⁻, Br⁻, I⁻, ClO₄⁻, ASF₆⁻, CH₃CO₂⁻, CF₃SO₃⁻, N(CF₃SO₂)₂⁻, or C(CF₂SO₂)₃⁻, or a combination thereof. For example, the electrolyte salt may be lithium-based salt, e.g., at least one selected from the group consisting of LiPF₆, LiBF₄, LiSbF₆, LiAsF₆, LiN (SO₂C₂F₅)₂, Li(CF₃SO₂)₂N, LiN (SO₃C₂F₅)₂, LiC₄F₉SO₃, LiClO₄, LiAlO₂, LiAlCl₄, LiN(CₓF₂ₓ₊₁SO₂) (C_{y}F2_{y+1}SO₂), LiCl, Lil, and LiB(C₂O₄)₂. Here, ‘x’ and ‘y’ each denote a natural number.

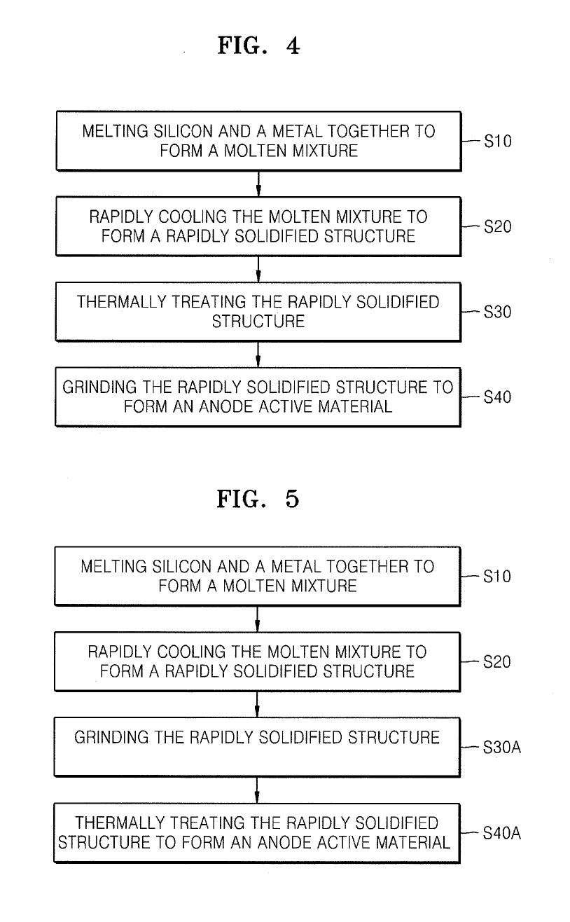

FIG. 4 is a flowchart illustrating a method of manufacturing an anode active material 13 included in an anode 10 of a secondary battery 1 according to an embodiment of the present invention.

Referring to FIG. 4, silicon and a metal material are melted together to form a molten mixture (step S10). The metal structure may include Al, Cu, Zr, Ni, Ti, Co, Cr, V, Mn, and Fe. For example, in the current embodiment, the metal material may include Ti and Ni. The silicon and the metal material may be melted together, for example, by generating induced heat of the silicon or the metal material through high-frequency induction using a high-frequency induction furnace.

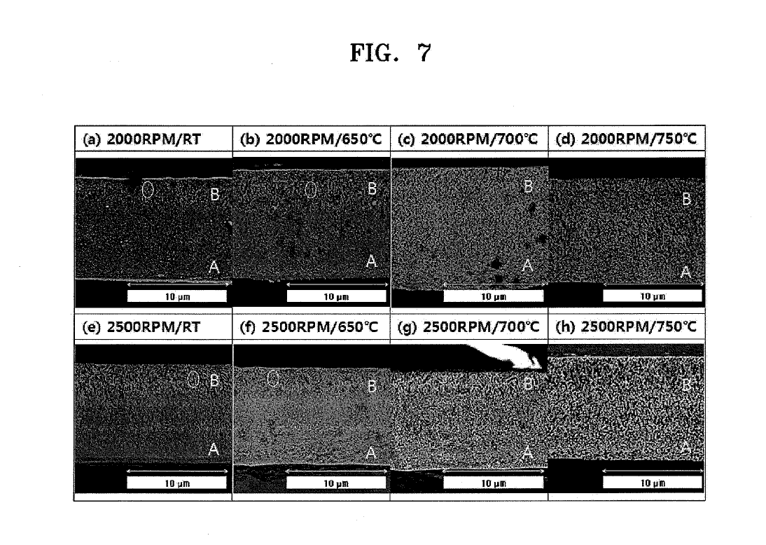

Then, the molten mixture is rapidly cooled to be solidified, thus forming a rapidly solidified structure (step S20). The rapidly cooling of the molten mixture may be performed using a melt spinner illustrated in FIG. 6 and will be described in detail with reference to FIG. 6 below. However, it would be apparent to those of ordinary skill in the art that the rapidly solidified structure may be formed using another apparatus other than the melt spinner, e.g., an atomizer. The rapidly solidified structure may include silicon single phases and silicon-metal alloy phases.

Then, the rapidly solidified structure is thermally treated (step S30). Through the thermal treatment, crystals or phases included in the rapidly solidified structure may be recrystallized and/or may be grown to crystal grains. The thermal treatment may be performed at a vacuum atmosphere, an inert atmosphere including nitrogen, argon, helium, or a mixture thereof, or a reducing atmosphere including hydrogen or the like. Also, the thermal treatment may be performed at a vacuum state or may be performed using an inert gas, such as nitrogen, argon, or helium, in a circulational manner. The thermal treatment may be performed at 400° C. to 800° C. for one to sixty minutes. Also, after the thermal treatment is performed, the rate of rapid cooling the molten mixture may be 4° C./min to 20° C./min. Also, the thermal treatment may be performed at a temperature that is lower by about 200° C. or less than a temperature at which the rapidly solidified structure is melted. The microstructure of the rapidly solidified structure may change due to the thermal treatment, as will be described in an experimental example below.

Then, the thermally treated rapidly solidified structure is grinded to form an anode active material (step S40). The anode active material may be powder, each of particles of which has a diameter of several to several hundreds of micrometers. Each of the particles of the powder may have a diameter of 1 μm to 10 μm, and particularly, a diameter of 2 μm to 4 μm.

The anode active material may correspond to the anode active material 13 described above with reference to FIG. 1. Also, the anode 10 of the secondary battery 1 according to an embodiment of the present invention may be manufactured by mixing the anode active material with the anode binder 14 and so on to form slurry, and applying the slurry on the anode current collector 11, as described above with reference to FIG. 1.

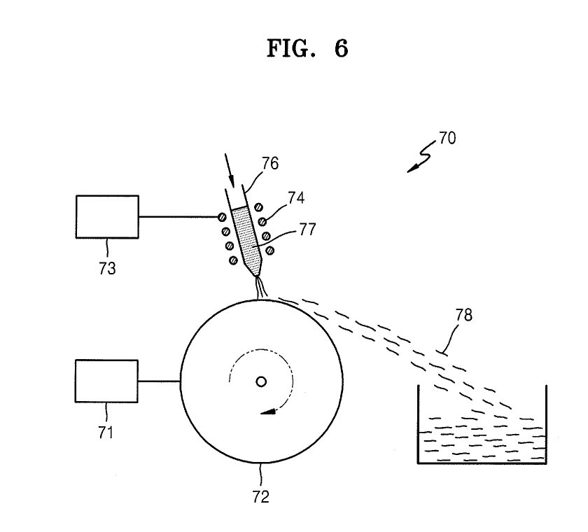

FIG. 5 is a flowchart schematically illustrating a method of manufacturing an anode active material 13 included in an anode 10 of a secondary battery 1 according to another embodiment of the present invention. The method of FIG. 5 is similar to the method of FIG. 4, except that a rapidly solidified structure is grinded and is then thermally treated.

Referring to FIG. 5, first, silicon and a metal material are melted together to form a molten mixture (step S10). Then, the molten mixture is rapidly cooled to be solidified, thus forming a rapidly solidified structure (step S20). Then, the rapidly solidified structure is grinded (step S30a). The grinded rapidly solidified structure may be power, each of the particles of which has a diameter of several to several hundreds of micrometers. Then, the grinded rapidly solidified structure is thermally treated to form an anode active material (step S40a). Through the thermal treatment, crystals or phases included in the rapidly solidified structure may be recrystallized and/or may be grown to crystal grains. The anode active material may correspond to the anode active material 13 described above with reference to FIG. 1.

FIG. 6 is a schematic diagram illustrating a method of forming an anode active material according to an embodiment of the present invention.

Referring to FIG. 6, an anode active material according to an embodiment of the present invention may be formed using a melt spinner 70. The melt spinner 70 includes a cooling roll 72, a high-frequency induction coil 74, and a tube 76. The cooling roll 72 may be formed of metal that has high thermal conductivity and that is highly resistant to thermal shock, e.g., copper or a copper alloy. The cooling roll 72 may be rotated by a rotating unit 71, such as a motor, at a high speed of 1000 to 5000 rpm (revolutions per minute). High-frequency power may be supplied to the high-frequency induction coil 74 via a high-frequency inducing unit (not shown), thereby inducing a high frequency to flow through a material inserted into the tube 76. A cooling medium flows through the high-frequency induction coil 74 for cooling. The tube 76 may be formed of a material having a low reactivity with respect to the inserted material and high heat-resistant properties, e.g., quartz or fire-resistant glass. In the tube 76, high frequency is induced by the high-frequency induction coil 74 and materials that are to be melted, e.g., silicon and a metal material, are inserted. The high-frequency induction coil 74 may be wound to surround the tube 76, and may induce high-frequency to melt the materials inserted into the tube 76, thereby forming a molten mixture 77 in a liquid state or having fluidity. In this case, the tube 76 may be in a vacuum state or at an inert atmosphere to prevent undesired oxidization of the molten mixture 77. When the molten mixture 77 is formed, a compressed gas (e.g., an inert gas, such as argon or nitrogen) is injected into the tube 76 at a side of the tube 76 (as indicated by an arrow), and the molten mixture 77 is discharged via a nozzle formed at another side of the tube 76 due to the compressed gas. The molten mixture 77 discharged from the tube 76 contacts the cooling roll 72 that is rotating, and is then rapidly cooled by the cooling roll 72 to obtain a rapidly solidified structure 78. The rapidly solidified structure 78 may have a ribbon shape, a flake shape, or powder shape. By rapid cooling the molten mixture 77 using the cooling roll 72, the molten mixture 77 may be cooled at high rate, e.g., at a rate of 10³ to 10⁷° C./second. The cooling rate may vary according to a speed of rotation, material, or temperature of the cooling roll 72.

Preparation Example

A method of forming an anode by using an anode active material including silicon, nickel, and titanium according to a preparation example will now be described.

First, silicon, nickel, and titanium were melted together to form a molten mixture, and then the molten mixture was rapidly cooled to be solidified by using the melt spinner 70 of FIG. 6, thereby forming a rapidly solidified structure including silicon, nickel, and titanium. In a composition of silicon, nickel, and titanium, silicon was about 68 at %, nickel was about 16 at %, and titanium was about 16 at %. However, the present invention is not limited thereto, and nickel may be 10 at % to 20 at %, titanium may be 10 at % to 20 at %, and silicon and other unavoidable impurities may be 60 at % to 80 at %. Alternatively, the anode active material may further other additives.

The rapidly solidified structure was formed by spraying the molten mixture of silicon, nickel, and titanium onto the cooling roll 72 of the melt spinner 70 while rotating the cooling roll 72 at 2,000 rpm and 2,500 rpm.

Then, the rapidly solidified structure was thermally treated. The thermal treatment was performed at 650° C., 700° C., and 750° C., respectively, for about one hour, under a vacuum atmosphere maintained at about 3×10⁻² Torr. The thermal treatment was performed while increasing room temperature to about 10° C./min, and the molten mixture of silicon, nickel, and titanium were rapidly cooled for about two hours after the thermal treatment was ended.

The thermally treated rapidly solidified structure was grinded through a ball milling process under an inert gas atmosphere for about forty-eight hours to form an anode active material. Then, the grinded anode active material was mixed with a polymer-based anode binder, and the resultant mixture was applied on an anode current collector of a copper plate to form an anode. In this case, a binder and the anode active material may be mixed at a weight ratio of 1 and 10.

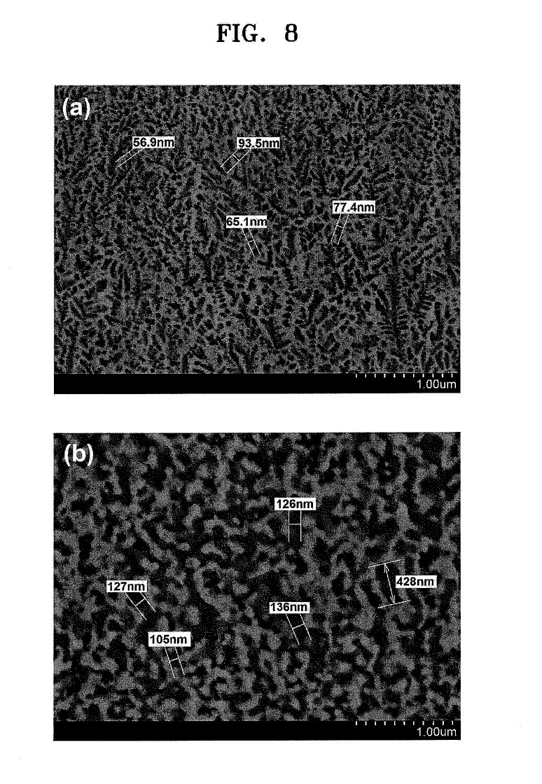

FIG. 7 illustrates scanning electronic microscopic (SEM) image illustrating microstructures of rapidly solidified structures including silicon, nickel, and titanium, according to an embodiment of the present invention. In FIG. 7, (a), (b), (c), and (d) denote cases in which the speed of rotation of the cooling roll 72 of FIG. 6 was 2,000 rpm, and (e), (f), (g), and (h) denote cases in which the speed of rotation of the cooling roll 72 was 2,500 rpm. Also, (a) and (e) denote cases in which the molten mixture of silicon, nickel, and titanium was rapidly cooled to be solidified and was then not thermally treated. (b) and (f) denote cases in which rapidly solidified structures were thermally treated at 650° C. for one hour. (c) and (g) denote cases in which solidified bodies were thermally treated 700° C. for one hour. (d) and (h) denote cases in which solidified bodies were thermally treated at 750° C. for one hour. In FIG. 7, silicon single phases were shown in black, and silicon-metal alloy phases were shown in gray.

Referring to FIG. 7, the solidified bodies each include a region A cooled when the molten mixture directly contacted the cooling roll 72, and a region B cooled when the molten mixture was directly exposed to air. The microstructures of the solidified bodies were hardly influenced by the speeds of rotation of the cooling roll 72.

At room temperature (RT), the solidified bodies each had a finer microstructure in the region A and a less fine microstructure in the region B (see (a) and (e)). Each of the fine structures included silicon single phases and silicon-metal alloy phases. In other words, in the region A, crystalline particles were formed to be very fine since the molten mixture directly contacted a cooling wheel of the melt spinner and thus was rapidly cooled at a relatively high rate, whereas in the region B, crystalline particles were formed to be less fine than the crystalline articles in the region A since the molten mixture was relatively spaced from the cooling wheel and was mostly cooled by air at a relatively low rate. In particular, in the B region, a dendrite structure was formed (indicated by a white circle). In general, the dendrite structure is grown along a longitudinal direction of each of the solidified bodies (i.e., a direction perpendicular to a cross-section of each of the solidified bodies). That is, a growth direction of the dendrite structure may correspond to a cooling direction of the solidified bodies. The dendrite structure may represent a directionality in which each of the solidified bodies was grown. The silicon single phases may represent a directionality in which each of the solidified bodies was grown from the region A to the region B.

When thermally treated at 650° C., the solidified bodies are not remarkably different from those at room temperature (see (b) and (f)). Here, the sizes of crystalline particles in the regions A and B are almost the same as at the room temperature, and a dendrite structure was formed in the region B (indicated by a white circle). Thus, the solidified bodies were not or hardly grown to crystal grains at 650° C.

When thermally treated at 700° C. (see (c) and (g)) and when thermally treated at 750° C. (see (d) and (h)), the fine structures of the solidified bodies were remarkably different from those at the room temperature and 650° C. In the regions A and B, crystalline particles formed through rapid solidification were large, and particularly, no dendrite structure was found in the region B. This means that through the thermal treatment, silicon single phases were recrystallized to be grown to crystal grains and a dendrite structure was thus decomposed. Also, the directionality in which the silicon single phases are grown may be canceled. The silicon single phases and silicon-metal alloy phases formed a spongiform fine structure. The silicon single phases were evenly distributed having no directionality, compared to the silicon-metal alloy phases. In particular, when the result of the melting was thermally treated at 750° C., the silicon single phases were remarkably grown to crystal grains such that the fine structures in the regions A and B were substantially the same. Also, the silicon-metal alloy phases were grown to crystal grains.

Lithium ions may be reversibly intercalated to/deintercalated from the silicon single phases during charge/discharge modes. In other words, the silicon single phases form an alloy with lithium during a charge mode, and discharge the lithium to return to the silicon single phases during a discharge mode. On the other hand, the silicon-metal alloy phases do not electrochemically react with lithium during the charging/discharging mode. However, the silicon-metal alloy phases may be distributed around the silicon single phases to buffer a volume change in the silicon single phases. When the silicon single phases and silicon-metal alloy phases form a spongiform fine structure, such a volume change can be more efficiently buffered. Furthermore, in the spongiform structure, lithium ions may be directly supplied to the silicon single phases. Also, due to the spongiform structure, the silicon single phases may be highly resistant to stress caused by a volume change in the silicon single phases when lithium ions are intercalated thereinto, thereby suppressing cracks therein. Also, when the silicon single phases are finely and evenly distributed, the silicon single phases are highly resistant to the stress caused by the volume change may increase, thereby suppressing cracks therein. Furthermore, when the silicon single phases are finely and evenly distributed, the degree of dispersion of lithium ions in a diffusion path of the lithium ions may be reduced, thereby achieving uniform charge/discharge efficiency.

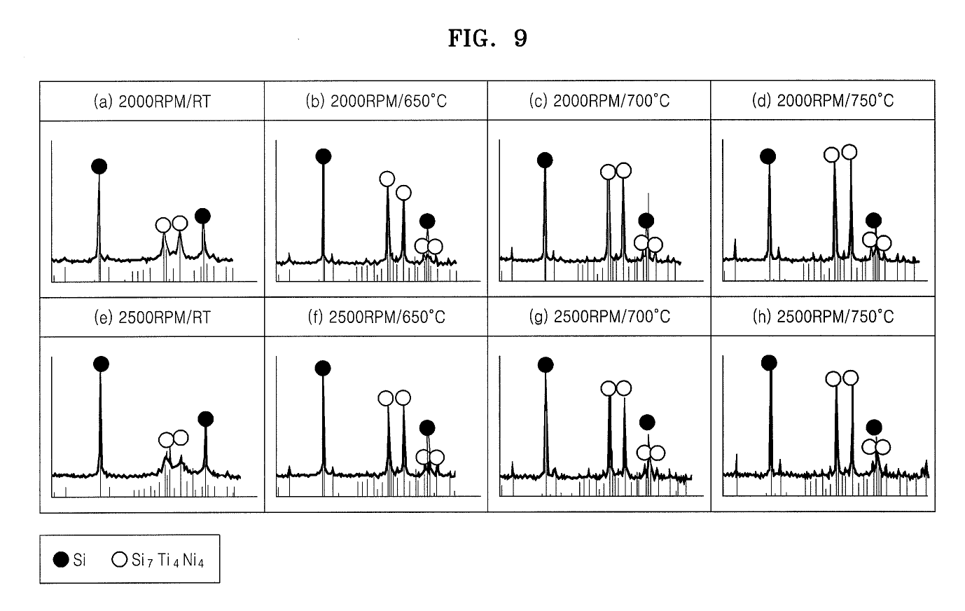

FIG. 8 illustrates SEM images illustrating microstructures of rapidly solidified structures including silicon, nickel, and titanium, according to another embodiment of the present invention. FIG. 8 illustrates a case in which the speed of rotation of the cooling roll 72 of FIG. 6 was 2,500 rpm. In FIG. 8, (a) is a photo in which the region B of FIG. 7(e) was enlarged, and (b) is a photo in which the region B of FIG. 7(h) was enlarged. Here, silicon single phases were shown in black and silicon-metal alloy phases were shown in gray.

Referring to FIG. 8(a), a rapidly solidified structure had a fine microstructure at room temperature right after a molten mixture of silicon, nickel, and titanium was rapidly cooled to be solidified, in which a large number of dendrite structures were shown. In this case, silicon single phases each have a diameter of less than 100 nm.

Referring to FIG. 8(b), a rapidly solidified structure had a fine microstructure obtained when the molten mixture was rapidly cooled to be solidified and thermally treated at 750° C., in which few dendrite structures were shown. In this case, silicon single phases each had a diameter of 100 nm or more, and particularly, a diameter of 100 nm to 300 nm. The silicon single phases and silicon-metal alloy phases form a spongiform fine structure.

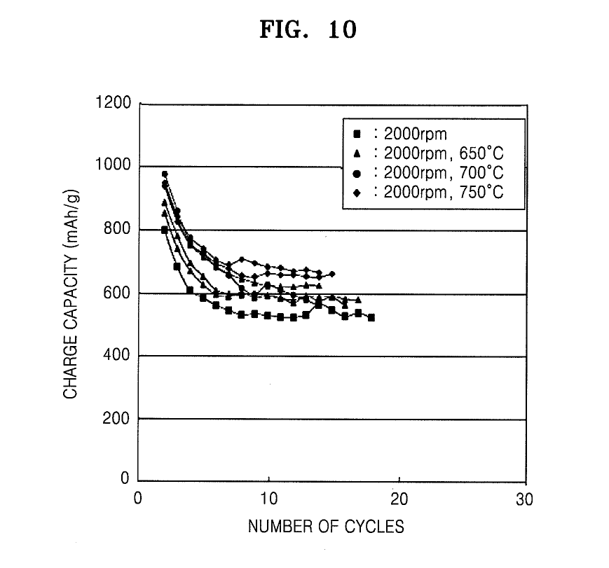

FIG. 9 illustrates graphs showing X-ray diffraction patterns of solidified bodies including silicon, nickel, and titanium according to an embodiment of the present invention. In FIG. 9, (a), (b), (c), and (d) denote cases in which the speed of rotation of the cooling roll 72 of FIG. 6 was 2,000 rpm, and (e), (f), (g), and (h) denote cases in which the speed of rotation of the cooling roll 72 was 2,500 rpm. Also, (a) and (e) denote cases in which a result of melting silicon, nickel, and titanium was rapidly cooled to be solidified without being thermally treated. (b) and (f) denote cases in which solidified bodies were thermally treated at 650° C. for one hour. (c) and (g) denote cases in which solidified bodies were thermally treated at 700° C. for one hour. (d) and (h) denote cases in which solidified bodies were thermally treated at 750° C. for one hour.

Referring to FIG. 9, X-ray diffraction of the solidified bodies was hardly influenced by the speed of rotation of the cooling roll 72.

An X-ray diffraction pattern of silicon single phases of a rapidly solidified structure was analyzed as below. In the rapidly solidified structure, the silicon single phases (indicated by black circles) were rapidly cooled to be solidified and had a peak value before being thermally treated (i.e., at room temperature). This means that the silicon single phases were mostly crystallized through the rapidly-cooling solidification. Also, since the peak value of the silicon single phases hardly changed, the crystalline states of the silicon single phases hardly changed even when they were thermally treated. According to the analysis of the fine structure described above, the silicon single phases were grown to crystal grains when they were thermally treated at 700° C. or more.

An X-ray diffraction pattern of silicon-metal alloy phases of a rapidly solidified structure was analyzed as below. In the rapidly solidified structure, the silicon-metal alloy phases (indicated by gray circles) were rapidly cooled to be solidified and had a relatively low peak value before they were thermally treated (i.e., at room temperature). This means that the degree of crystallization of the silicon-metal alloy phases was low. In other words, some of the silicon-metal alloy phases were crystallized and the remaining silicon-metal alloy phases were in an amorphous state. On the other hand, the peak value of the silicon-metal alloy phases increase when they were thermally treated at 650° C. That is, the degree of crystallization of the silicon-metal alloy phases increased. Since the peak value of the silicon-metal alloy phases at 650° C. was substantially the same as those at 700° C. and 750° C., it means that the crystallization of the silicon-metal alloy phases was almost completed at a temperature of 650° C. or less. Here, the silicon-metal alloy phases may have a crystalline structure of Si₇Ti₄Ni₄, and may further have crystalline structures of Si₂Ti and SiNi₃. According to the analysis of the fine structures described above, the silicon-metal alloy phases were grown to crystal grains at 700° C. or more.

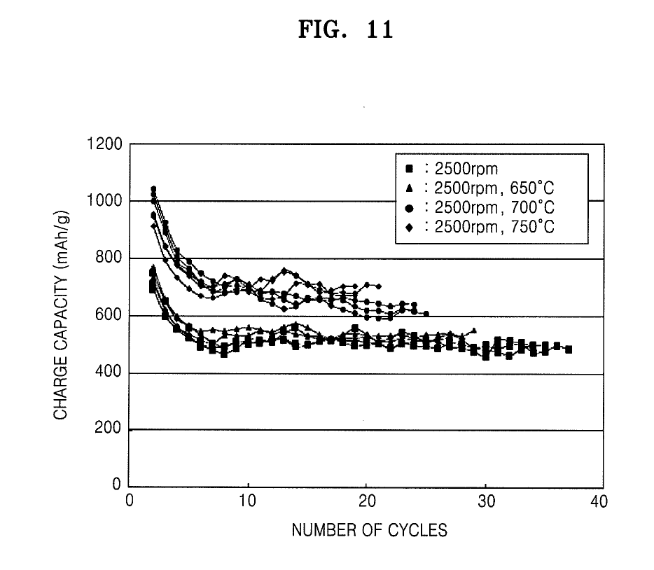

FIGS. 10 and 11 are graphs showing a relationship between a capacity change and number of cycles of a secondary battery having an anode formed using a rapidly solidified structure including silicon, nickel, and titanium according to an embodiment of the present invention. FIG. 10 illustrates a case in which the speed of rotation of the cooling roll 72 of FIG. 6 was 2,000 rpm. FIG. 11 illustrates a case in which the speed of rotation of the cooling roll 72 was 2,500 rpm.

Referring to FIG. 10, a charging capacity was high when the rapidly solidified structure was thermally treated (indicated by solid triangles, circles, and diamonds), compared to when the rapidly solidified structure was not thermally treated (indicated by solid squares). When a charging/discharging cycle is initially performed, the charging capacity was about 800 mAh/g when the rapidly solidified structure was not thermally treated, and was about 1000 mAh/g when the rapidly solidified structure was thermally treated at 700° C. (indicated by the solid circles) or when the rapidly solidified structure was thermally treated at 750° C. (indicated by the solid diamonds). Thus, the charging capacity was increased by about 20% to 25% when the rapidly solidified structure was thermally treated. In all the cases, as a number the charging/discharging cycle is performed increased, the charging capacity decreased. The charging capacity was higher when the thermal treatment was performed than when the thermal treatment was not performed. When the charging/discharging cycle was performed about fifteen times, the charging capacity was about 520 mAh/g when the thermal treatment was not performed and was about 630 mAh/g when the thermal treatment was performed at 750° C. Thus, the charging capacity increased by about 21% through the thermal treatment. Accordingly, the higher the temperature of the thermal treatment, the higher the charging capacity. Such a trend was also shown in the case of the charging/discharging cycle. That is, the initial efficiency and cycle characteristics of the secondary battery may be improved through the thermal treatment. In particular, the higher the temperature of the thermal treatment, the more the initial efficiency and cycle characteristics of the secondary battery were improved.

FIG. 11 shows a result that is substantially the same as that in FIG. 10, except that a charging capacity when a thermal treatment was performed at 650° C. was substantially the same as when the thermal treatment was not performed. Thus, when the thermal treatment was performed at 650° C., the charging capacity was not remarkably improved. Referring to FIG. 10, the initial efficiency and cycle characteristics of a secondary battery were improved through the thermal treatment. In particular, the higher the temperature of the thermal treatment, the more the initial efficiency and cycle characteristics of a secondary battery were improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An anode active material for a secondary battery, comprising:
silicon single phases; and
silicon-metal alloy phases distributed around the silicon single phases,
wherein the silicon single phases have a fine microstructure in which crystalline particles obtained through rapid-cooling solidification are thermally treated to be grown to crystal grains.

2. The anode active material of claim 1, wherein the silicon single phases comprise a fine microstructure obtained when a dendrite structure formed through the rapid-cooling solidification is decomposed.

3. The anode active material of claim 1, wherein the silicon single phases comprise a fine microstructure, the directionality of growth of which is canceled through the thermal treatment.

4. The anode active material of claim 1, wherein the silicon single phases and the silicon-metal alloy phases form a spongiform fine structure.

5. The anode active material of claim 1, wherein the silicon single phases comprise crystal grains, each of which has a diameter of 100 nm to 300 nm.

6. The anode active material of claim 1, wherein a degree of crystallization of the silicon-metal alloy phases is higher than that of initial phases obtained through the rapid-cooling solidification.

7. The anode active material of claim 1, wherein the silicon-metal alloy phases comprise at least one metal selected from the group consisting of Ti, Ni, Fe, Mn, Al, Fe, Cr, and Co.

8. The anode active material of claim 1, wherein the silicon-metal alloy phases comprise silicon, nickel, and titanium.

9. The anode active material of claim 1, wherein the thermal treatment is performed at 700° C. to 750° C.

10. A method of manufacturing an anode active material for a secondary battery, the method comprising:
melting silicon and a metal material together to form a molten mixture;
rapid cooling the molten mixture to be solidified to form a rapidly solidified structure including silicon single phases and silicon-metal alloy phases;
thermally treating the rapidly solidified structure to grow the silicon single phases, the silicon-metal alloy phases, or both the silicon single phases and the silicon-metal alloy phases to crystal grains; and
forming an anode active material by grinding the thermally treated rapidly solidified structure.

11. A method of manufacturing an anode active material for a secondary battery, the method comprising:
melting silicon and a metal material together to form a molten mixture;
rapid cooling the molten mixture to be solidified to form a rapidly solidified structure including silicon single phases and silicon-metal alloy phases;
grinding the thermally treated rapidly solidified structure; and
forming an anode active material by thermally treating the grinded rapidly solidified structure such that the silicon single phases, the silicon-metal alloy phases, or both the silicon single phases and the silicon-metal alloy phases are grown to crystal grains.

12. A secondary battery comprising:
an anode active material including:
silicon single phases; and
silicon-metal alloy phases distributed around the silicon single phases,
wherein the silicon single phases have a fine structure in which crystalline particles obtained through rapid-cooling solidification are thermally treated to be grown to crystal grains.
